(19) United States
(12) Patent Application Publication
(10) Pub. No.: US 2003/0117492 A1
(43) Pub. Date: Jun. 26, 2003

(54) Method and a system for monitoring a paper web or the like

(75) Inventor: Risto Jokela, Tampere (FI)

Correspondence Address: STEINBERG & RASKIN, P.C., 1140 AVENUE OF THE AMERICAS, 15th FLOOR, NEW YORK, NY, 10036-5803, US

(73) Assignee: Metso Paper Automation Oy

(21) Appl. No.: 10/295,388

(22) Filed: Nov. 15, 2002

(30) Foreign Application Priority Data
Nov. 15, 2001 (FI) 20012224

(51) Int. Cl. H04N 7/18; H04N 9/47

(52) U.S. Cl. 348/88; 382/111

(57) ABSTRACT

In the method for monitoring a paper web or the like, the properties and state of the paper web (W) or the like, travelling in a paper machine or in a finishing machine for paper are monitored by observing the travelling paper web with one or more image-forming systems based on camera technique, and the properties of the web are measured with a system comprising one or more physical on-line measurement methods. The systems use different observation devices for monitoring the web. At least two different systems, which use different observation devices, are integrated at least partly by placing the web observation devices in the same machine part, by using software of different systems on the same substation (8), and/or by using the same user interface software for both systems in the workstation (9) in the user interface. The observation devices of different systems can be cameras (2) and sensors, which are placed in the same measurement beam or frame (1) extending across the web (W).

### FIELD OF THE INVENTION

The invention relates to a method for monitoring a paper web or the like and a system for monitoring a paper web or the like.

### BACKGROUND OF THE INVENTION

In a paper machine or a finishing machine for paper, it is known to monitor the paper web travelling in it with many different measurement and monitoring systems.

In paper production there are, first of all, methods in use for monitoring the paper web with observation devices, which produce an image of the target and thus enable visual monitoring of the web with the help of an image obtained of the target. A typical example of this is paper web break monitoring (paper web runnability monitoring, i.e. WRM), which, for example, is at present performed by means of a video camera. Video cameras, which continuously image the web, are installed at certain locations of the paper web. The images are saved in a storage medium, for example on a tape, which can later be used to examine, for example, the reasons that caused the break. Thus the machine element or process parameter that has caused the break can be controlled and breaks can be avoided in the future. An example of a break monitoring system is presented in publication EP-837323. Another monitoring system utilizing image forming observation devices is web defect detection (web inspection system, i.e. WIS). The system in question is one that observes defects (holes, spots, splashes, streaks, etc.) in a travelling paper web. Image data that has been saved during monitoring can be utilized here as well. An example of such a system is in e.g. publication WO 01/02840. The process can also be controlled with the data.

In addition, publication DE19920154 discloses a manner for measuring formation from a passing web with CCD matrix cameras imaging the web, which can cover the whole width of the web. The results can be used in process control. With these cameras it is also possible to observe web defects.

To monitor the process with image formation (web break monitoring, web defect detection), video cameras have been placed at suitable locations in the wet or dry end of a paper machine, or in a finishing machine for paper.

In addition to the methods presented above, a continuous monitoring of properties of paper by using measuring sensors is in use. Keeping the quality of produced paper within certain predetermined limits requires the measuring of paper web properties with some physical measurement method. Typically the variable in question is a controlled variable, whose value is influenced with one or more manipulated variables that are applied to the production process. Measurement is performed in an on-line type manner with measurement sensors that are attached to, for example, a measurement frame or a measurement beam. The measurement sensor may also be attached to a traversing measurement carriage, which travels back and forth in a cross direction of the web in order to perform measurement for the full width of the web. Most physical measurement methods are based on observation of changes in radiation directed at the web. Sensors, processing the measurement signals, and corresponding controllers for producing manipulated variables are a part of a quality control system (i.e. QCS), that is, they perform process control in order to keep paper quality desired. An essential part of the system is information management, such as collecting the acquired measurement values, displaying them on terminals, and saving them.

The measurement frame, which may include one or more sensors, is connected to the quality control system and is in paper machines and board machines usually located in the dry end at a suitable location for performing measurements. Similarly, a finishing machine for paper or board (e.g. coating machine) usually has a measurement frame to measure the properties the paper or board has acquired in the treatment. Paper and board machines, for example, usually have both a quality control system based on physical online measurements, and an inspection system (defect detection), which is based on visual monitoring with camera technique. In addition, a camera system, which performs paper web runnability monitoring, is further provided especially for printing paper machines.

There is generally lack of space on paper machines and board machines, as well as finishing machines for paper and board. Placement of different measuring beams, frames and cameras may then be difficult, and this problem occurs both in new machines and in connection with machine reconstructions. As a physical entity, a production machine that includes several systems is difficult for maintenance. Lack of space also increases risks to occupational safety. In addition, from the point of view of information management, several systems are difficult to use.

### OBJECTS AND SUMMARY OF THE INVENTION

It is a purpose of the invention to eliminate the aforementioned drawbacks and to present a method and system, which both by their physical implementation and function take less space and are simpler, as well as are easier for the user to operate. To achieve this purpose, the method is primarily characterized in what will be presented in the characterizing part of the appended claim 1. At least two different systems, which use different observation devices, are integrated at least partly. This means that the web observation devices, which belong to different systems, can be placed in the same machine part, e.g. the same element extending across the web. Software of different systems can be operated in the same substation. Finally, it is possible in the workstation in the user interface to use a user interface software, which is the same for both systems.

For example, both a physical non-imaging measurement method for determining and controlling the properties of a paper web, and some camera technique for monitoring the web (WRM, WIS) can thus be integrated together as to the placement of observation devices of both systems, as to the placement of various software, and/or as to the user interface software of the user interface. The result can be a complete integration of both systems to a single quality control and monitoring system, or integration of some parts of the systems to an entity functioning together. First of all, the observation devices (cameras, sensors) that are in monitoring contact with the web can be located in the same structure extending across the web. The information received from these devices (physical measurement methods performed by the sensors: information in numerical values; camera technique: image data) can be processed in the same data processing system, e.g. with the system and application software that run in the same substation, and the information can be monitored and the system can be controlled at the user end in the same workstation with the same user interface software.

As a physical solution appearing close to the web, one or more cameras and one or more sensors of the physical measurement method can be placed in the same measurement beam or measurement frame extending across the machine. Thus the need for space is diminished and e.g. cabling from monitoring point to the data processing device is easier to implement. Before this, there have been separate substations for separate systems, where the software of each system (system programs and application programs) has been running. When monitoring has been performed in the user interface on the workstation terminal, it has been necessary to change the user interface program when moving from one system to another. In the system according to the invention, which monitors the paper web, it is possible to use one substation, where the software of both systems are running, and on the terminal of the workstation (for example on the work station display), a user interface software shared by two different systems can be running.

### BRIEF DESCRIPTION OF THE DRAWINGS

In the following, the invention will be described in more detail with reference to the appended drawings, in which

FIG. 1 shows an integrated quality control system as a diagram, and

FIGS. 2 and 3 show some practical solutions for implementing the integration in the measurement beam or frame.

### DETAILED DESCRIPTION OF THE INVENTION

Here, when a system is mentioned when referring to the invention, what is meant is an entity formed by physical components and different software, such as software controlling its operation and its user interface software.

Systems that can be combined into the same paper web monitoring and controlling system, include

1) WRM, web runnability monitoring, which is connected to web break monitoring, and which saves an image of the monitored target automatically as a result of the web break signal. The observation device is a camera, which images the web continuously (continuously forms a 2-dimensional image of the target), such as a video camera, which produces an image that is saved for later observation only under the effect of an external signal.

2) WIS, web inspection system, which is used to monitor web details. The observation device is a camera, which continuously images the web surface, and which images points that can be used to form a 2-dimensional image, such as a line scan camera or a matrix camera. The targets that are searched from the web are defects caused by the paper making process or the finishing process of paper (holes, spots, splashes, streaks). The obtained information can be used in process control. Also in this case the images of the web can be saved so that they can be inspected later.

3) Quality control performed with measurement sensors, which is based on a physical on-line measurement method of the web and differs from the aforementioned two camera monitoring systems in that it represents non-imaging web monitoring, which gives as result a numerical value that represents a web property, which has been derived from the measurement signal sent by a sensor. Measurement sensors are connected to the quality control system (QCS), which is described above. One measurement beam or frame can have two or more measurement sensors, which measure a different property from the passing web, and which are arranged in a scanning head on a carriage that travels back and forth across the web.

According to the invention, a quality control system implemented with the help of measurement sensors and at least one camera monitoring system are combined at least partly to the same system. Combining can be performed mechanically by developing a new mechanical solution for the measurement beam or frame, by using software of both systems on the same substation and/or by using the same user interface software in the user interface of the workstation.

One or several physical on-line measurement method of the web and web monitoring performed with camera technique in order to create visually observable image require an observation device that is in observation connection to the web (in the measurement method a sensor and in the camera technique a camera, which performs imaging that can be used to continuously create a 2-dimensional image of the target). On the other hand, in the user interface the user has a possibility to control the functioning of the system. In the case of a measurement method, the user interface display device may display numerical values of the measured variables and information on the control events of the process. In the web monitoring performed with the help of a camera, the user interface has a monitor (display), where the video image sent by the camera is shown. Both systems require their own programs to keep them running and to control them.

According to the invention, at least one physical measurement method for quality control (QCS) and at least one camera monitoring system (WIS or WRM) is integrated to the same structure as to the observation devices of the systems, to the same physical part of the system as to the software of the systems, and/or to the same user interface software as to the user interface. Integration can mean the placement of a sensor/sensors and a camera/cameras in the same measurement beam or frame at the observation end, the use of the software of each system at the same station, or the operation of the user interface (terminal) of both systems at the workstation with the same user interface software.

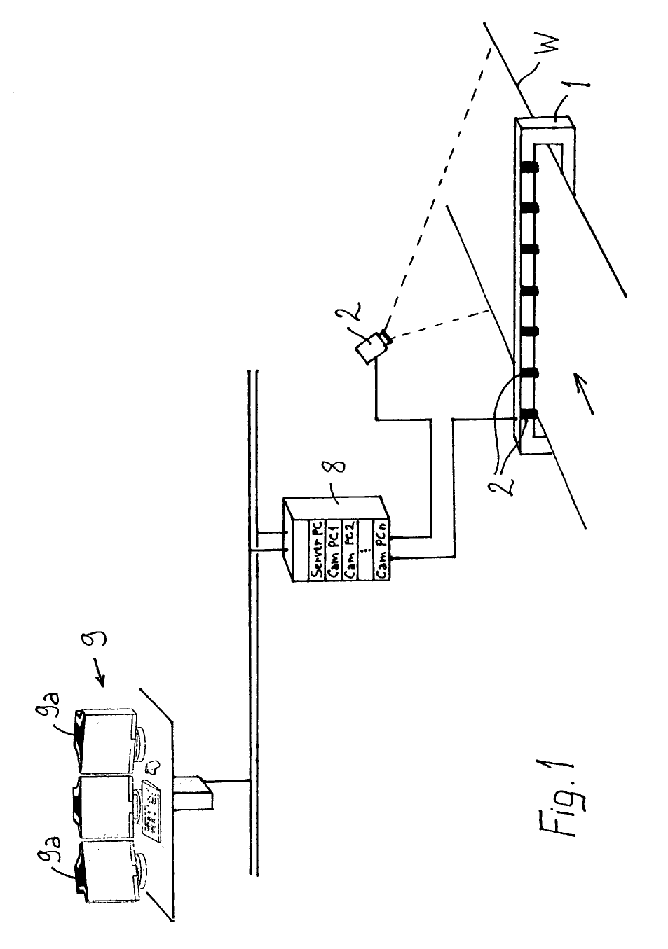

FIG. 1 presents examples of the alternatives described above. It presents a system based on distributed control system (DCS), in which firstly, in order to determine one or more properties influencing the paper quality on the passing continuous paper web W, one or more measurement sensors, which belong to the quality control system, are placed in the measurement frame 1, which in the present application is considered as one machine part. The physical measurement method performed by a sensor or sensors can, for example, be one of the following: moisture measurement, coating weight measurement, gloss measurement, roughness measurement, basis weight measurement, or thickness measurement. With the sensors placed in the same measurement frame 1, it is possible to also perform more than one of the aforementioned measurement methods. The measurement performed by the sensors is usually based on detecting the radiation directed at web W, and the type of radiation depends on the paper quality that is measured. The radiation can be IR-radiation (moisture, coating weight measurement), use visible light, e.g. laser (gloss, colour or roughness), or it can be radioactive (basis weight). Paper thickness is measured, for example, with magnetic methods. Sensors are usually placed in a scanning head on a traversing carriage, which travels back and forth in a cross direction of the web.

One or more cameras 2 are placed in the same measurement frame 1 together with one or more sensors, which cameras continuously create image of the passing web W. These cameras are especially a part of the web defect detection (WIS), which visually image the defects in the paper web. The cameras are usually placed several next to each other over the whole width of the web, so that together they can image the whole web. The structure of the measurement frame is described more in the detail later. Camera 2, which belongs to the paper web break monitoring (WRM), is mounted separately from the measurement frame 1.

The software of all three systems are run in the same substation 8. Correspondingly, the results of all systems can be monitored and the systems can be controlled in the same workstation 9 through the user interface, such as by different terminals 9a. For this purpose, the user interface has the same user interface software for all three systems.

The results that can be observed on the screen of the terminal can be images from a camera monitoring system (WRM and/or WIS) and numerical values from the quality control system.

According to FIG. 1, the integrated quality control system scales from a separate system (either QCS, WIS or WRM) to an extensive monitoring and quality control system. Integration is carried out at the level of equipment by using the same substations for running the software of each section. In addition to the measurement and control applications based on functional blocks, various image processing software can also be run on the process station. A video card, image capturing and processing software, as well as server software of image processing and image database software are required in the user interface of the workstation 9, such as in the PC-device of the station. Image processing of break monitoring and defect detection can be conducted with the same devices and software. Depending on the placement of the camera, a web break or a predetermined other event can be used as a web break signal, which causes the saving function in break monitoring.

An advantage of the invention is that when the different sections of automation are within the same device environment, it is possible to easily create a general tool for paper manufacturing control from the user interface and information applications of the process control system. Thus it is possible to start image material saved from break monitoring (WRM) and defect detection (WIS) on a list of events of the information application by, for example, focusing on the web break event. The image information system can automatically search the event from the correct period. Also the desired trend data from web measurements and field devices can be output with image information from the same period of events.

An additional advantage from integration is that the marking device of the web defect points used in the WIS-system, which places a mark in the paper web, for example, on its edge, which mark is detected in a later stage of web handling, can easily be controlled also on the basis of information provided by the measurement sensors (QCS-system) in order to make markings in the web corresponding to the fault information or other information from measurement sensors with the same marking device. Also, the information from WIS-system and QCS-system can be entered in the same file describing the qualities of the web, for example, the fault map.

The present runnability monitoring and inspection systems can be integrated in the same system according to the principles described above. Cameras can be placed on a beam or in separate camera enclosures. Illumination modules are correspondingly placed on an illumination beam or in separate light source enclosures. The light source can be implemented with LED-technique and function in IR-area and/or in visible light range. If defect detection (web inspection) is placed on a beam, it takes the movement of the traversing measurement carriage into account so that the defect detection is not disturbed.

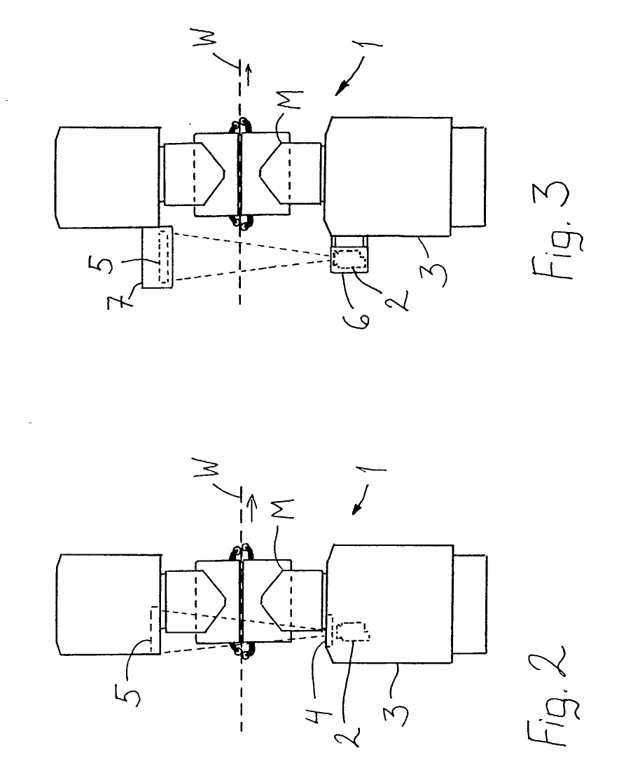

FIG. 2 shows one possible solution for implementing the integration as a cross-section of the measurement frame. For placing the defect detection cameras (cameras of the WIS), the present measurement frame 1 is developed so, that cameras 2 can be disposed, for example, inside beam 3, behind a transparent wall, e.g. glass window 4. A light source 5 has to be placed on the other side of web W, also inside a beam, behind a glass. Cameras 2 are placed in different points in cross direction of the web, advantageously so that they cover the entire width of web W. In the device solution of FIG. 2, a 100% coverage of the paper web is not reached because of measurement carriage M, which includes one or more measurement sensors, but the movement of traversing measurement carriage M can be taken into account program-technically, and the carriage can be prevented from causing web defect data.

Another alternative is to place separate camera and illumination beams 6 and 7 outside the frame 1 on brackets, as is described in FIG. 3. Also in this case the signal cabling and power and air supply can be provided through the measurement frame. Because measurement carriage M is not within observation area of cameras 2, a 100% coverage can be reached with this at every moment.

The same machine part, where the different observation devices of different systems are placed, can also be a machine element, a machine frame, or a frame construction of a machine, which is not specifically meant for a measurement beam or frame.

In addition to the simplicity of the system level, the system offers technical advantages in that the measured information and image material can be handled and saved in a centralized manner.

The invention is not restricted to the embodiments described above, but it can be modified within the scope of the inventive idea presented in the claims. Of the camera monitoring systems, at least WIS and the physical online measurement method based on measurement sensors can be integrated in the same system in one of the manners described above. It is also possible that the WRM-system is also integrated with the two abovementioned ones into the same system in one of the manners described above. Within the scope of the invention is also the idea, that only both of the camera monitoring systems (WRM, WIS) are integrated into one system, and the physical on-line measurement method constitutes a system of its own. Integrating different camera monitoring systems is advantageous from the point of view of image capturing and processing.

I claim:

1. A method for monitoring a paper web or the like, in which the properties and state of paper web (W) or the like travelling in a paper machine or in a finishing machine for paper, are observed by monitoring the travelling paper web with one or more image-forming systems based on camera technique, and the web properties are measured with a system comprising one or more physical on-line measurement methods, in which case the systems use different observation devices for monitoring the web, characterized in that at least two different systems, which use different observation devices, are integrated at least partly by placing the web observation devices in the same machine part, by using software of different systems on the same substation (8), and/or by using the same user interface software for both systems in the user interface in the workstation (9).

2. The method according to claim 1, characterized in that a system comprising one or more physical on-line measurement method, and at least one image-forming system based on camera technique is integrated at least partly.

3. The method according to claim 1, characterized in that the physical measurement methods comprise one or more of the following: moisture measurement, coating weight measurement, gloss measurement, roughness measurement, colour measurement, basis weight measurement, thickness measurement.

4. The method according to claim 2, characterized in that the computer program controlling the web monitoring based on image-forming camera technique, and the computer program controlling one or several physical on-line measurement methods are run on the same substation (8).

5. The method according to claim 2, characterized in that the image data of the web monitoring based on the image-forming camera technique, and the measurement results of one or more physical web on-line measurement methods are monitored and controlled on a user interface in the same workstation (9) by using the same user interface software.

6. The method according to claim 2, characterized in that the image data of the web monitoring performed with the image-forming camera technique and the measurement information of one or more physical web on-line measurement methods are derived from observation devices, such as one or more cameras (2) and one or more measurement sensors, placed in the same machine part, extending across the web, such as a measurement beam or frame (1).

7. The method according to claim 1, characterized in that one or more physical on-line measurement method is a part of a quality control system (QCS) of paper or the like, in which case the corresponding measurements are connected to the control of paper manufacturing process or finishing process of paper, and the monitoring with image-forming camera techniques belongs to a web runnability monitoring system (WRM) and/or a web defect detection system (WIS).

8. The method according to claim 1, characterized in that two different image-forming systems based on camera technique, such as the web break monitoring system (WRM) and the web defect detection (WIS), are integrated.

9. The method according to claim 8, characterized in that the computer programs controlling the different systems are run on the same substation (8).

10. The method according to claim 8, characterized in that the image data provided by different systems are monitored and controlled in a user interface in the same workstation (9) by using the same user interface software.

11. A system for monitoring a paper web (W) or the like, which is placed in connection with a paper machine or a finishing machine for paper, and which comprises different web observation devices, which are arranged to observe the paper web or the like running in a paper machine or a finishing machine for paper, and a user interface in an workstation to monitor the information provided by the observation devices and to control the system, characterized in that the system comprises at least two different systems that are at least partly integrated, and that use different observation devices, in which case the systems are integrated at least partly so that
a) the different observation devices of the web are placed in the same machine part,
b) the software of different systems are in the same substation (8), and/or
c) the systems have the same user interface software in the user interface of the workstation (9).

12. The system according to claim 11, characterized in that the at least partly integrated systems are a system comprising one or more physical online measurement methods, and at least one image-forming system based on camera technique.

13. The system according to claim 11, characterized in that in the system, one or several measurement sensors belonging to the physical on-line measurement method, and one or several cameras (2) belonging to the image-forming system based on camera technique are placed in the same machine part, extending across the paper web or the like, such as a measurement beam or frame (1).

14. The system according to claim 13, characterized in that one or several measurement sensors are placed in a traversing part, which travels in a cross direction of the web along the machine part, and cameras (2) are placed in different points in a cross direction of the web (W).
